(19) United States
(12) Patent Application Publication
(10) Pub. No.: US 2006/0119567 A1
(43) Pub. Date: Jun. 8, 2006

(54) Electrophoretic display unit

(76) Inventors: Guofu Zhou, Eindhoven (NL); Masaru Yasui, Kobe (JP); Neculai Ailenei, Heerlen (NL); Mark Johnson, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/559,357

(22) PCT Filed: Jun. 3, 2004
(86) PCT No.: PCT/IB04/50838

§ 371 Date: Dec. 6, 2005

(30) Foreign Application Priority Data
Jun. 11, 2003 (EP) 03101705.6

(51) Int. Cl. G09G 3/34

(52) U.S. Cl. 345/107

(57) ABSTRACT

Electrophoretic display units (1) are driven more flexibly by creating sequences of frame periods in which at least two frame periods of the sequence of frame periods have a different frame period duration and by selecting frame periods from a sequence of frame periods for providing driving pulses to the pixels (11). The number of possible gray values is increased, and the gray values can be generated more accurately. During the rest of the frame periods not chosen for driving the pixel (11), this pixel (11) keeps its gray value due to the bi-stable character. A frame period duration of a frame period is adapted by delaying a start of a next frame period. By supplying data-dependent signals having sections with a positive amplitude and with a negative amplitude, the net driving result is the difference between the sections with the positive and negative amplitudes, to further increase the number of possible gray values.

The invention relates to an electrophoretic display unit, to a display device comprising an electrophoretic display unit, to a method of driving an electrophoretic display unit and to a processor program product for driving an electrophoretic display unit.

Examples of display devices of this type are: monitors, laptop computers, personal digital assistants (PDAs), mobile telephones and electronic books, electronic newspapers and electronic magazines.

A prior art electrophoretic display unit is known from international patent application WO 99/53373. This patent application discloses an electronic ink display comprising two substrates, with one of the substrates being transparent and having a common electrode (also known as counter electrode) and with the other substrate being provided with pixel electrodes arranged in rows and columns. A crossing between a row electrode and a column electrode is associated with a pixel. The pixel is formed between a part of the common electrode and a pixel electrode. The pixel electrode is coupled to the drain of a transistor, of which the source is coupled to the column electrode and of which the gate is coupled to the row electrode. This arrangement of pixels, transistors and row and column electrodes jointly forms an active matrix. A row driver (select driver) supplies a selection signal for selecting a row of pixels and a column driver (data driver) supplies data signals to the selected row of pixels via the column electrodes and the transistors. The data signals correspond to data to be displayed, and form, together with the selection signal, a (part of a) driving signal for driving one or more pixels.

Furthermore, an electronic ink is provided between the pixel electrode and the common electrode provided on the transparent substrate. The electronic ink comprises multiple microcapsules of about 10 to 50 microns in diameter. Each microcapsule comprises positively charged white particles and negatively charged black particles suspended in a fluid. When a positive field is applied to the pixel electrode, the white particles move to the side of the microcapsule directed to the transparent substrate, and the pixel becomes visible to a viewer. Simultaneously, the black particles move to the pixel electrode on the opposite side of the microcapsule where they are hidden from the viewer. By applying a negative field to the pixel electrode, the black particles move to the common electrode on the side of the microcapsule directed to the transparent substrate, and the pixel appears dark to a viewer. Simultaneously, the white particles move to the pixel electrode on the opposite side of the microcapsule where they are hidden from the viewer. When the electric fields are removed, the display device remains in the acquired state and exhibits a bi-stable character.

To reduce the dependence of the optical response of the electrophoretic display unit on the history of the pixels, preset data signals are supplied before the data-dependent signals are supplied. These preset data signals comprise pulses representing energies which are sufficient to release the electrophoretic particles from a static state at one of the two electrodes, but which are too low to allow the particles to reach the other electrode. Because of the reduced dependence on the history, the optical response to identical data will be substantially equal, regardless of the history of the pixels. The underlying mechanism can be explained by the fact that, after the display device is switched to a predetermined state, for example a black state, the electrophoretic particles come to a static state. When a subsequent switching to the white state takes place, the momentum of the particles is low because their starting speed is close to zero. This results in a high dependence on the history which requires a long switching time to overcome this high dependence. The application of the preset data signals increases the momentum of the electrophoretic particles and thus reduces the dependence (and allows a shorter switching time).

Each update of the pixels of the electrophoretic display unit requires, per row, a row driving action for supplying the selection signal to the row for selecting (driving) this row, and a column driving action for supplying pulses, like, for example, pulses of the preset data signals and pulses of the data-dependent signals, to the pixels. The time-interval required for driving all pixels of all rows once (by driving each row one after the other and by driving all columns simultaneously once per row) is called a frame period.

So, during a first set of frames, the pulses of the preset data signals are supplied to the pixels, with each pulse having a duration of one frame period. The first pulse, for example, has a positive amplitude, the second one a negative amplitude, and the third one a positive amplitude etc. (alternating amplitudes). As long as the duration of these pulses is relatively short, the pulses do not change the gray value displayed by the pixel.

During a second set of frames comprising one or more frame periods, one or more pulses of the data-dependent signals are supplied. The data-dependent signals have a duration of zero, one, two to, for example, fifteen frame periods. Thereby, a data-dependent signal having a duration of zero frame periods, for example, corresponds with the pixel displaying full black (in case the pixel already displayed full black; in case of displaying a certain gray value, this gray value remains unchanged when driven by a pulse having a duration of zero frame periods, in other words when driven by a pulse having a zero amplitude). A data-dependent signal having a duration of fifteen frame periods comprises fifteen subsequent pulses and, for example, corresponds with the pixel displaying full white, and a data-dependent signal having a duration of one to fourteen frame periods comprises one to fourteen subsequent pulses and, for example, corresponds with the pixel displaying one of a limited number of gray values between full black and full white.

Due to all frames each having the same fixed duration, the driving of the electrophoretic display unit is highly inflexible. The number of gray values is limited, and cannot be increased, with the difference between two subsequent gray values being rather large.

The known electrophoretic display unit is disadvantageous, inter alia, due to the driving of the electrophoretic display unit being relatively inflexible.

It is an object of the invention, inter alia, to provide an electrophoretic display unit with a relatively flexible driver. The invention is defined by the independent claims. The dependent claims define advantageous embodiments.

An electrophoretic display unit according to the invention comprises
an electrophoretic display panel comprising a pixel;
a controller for generating a driving signal in dependence on an input image by selecting frame periods from a sequence of frame periods for providing pulses to the pixel, at least two frame periods of the sequence of frame periods having a different frame period duration; and
drivers for, providing the pulses to the pixel in response to the driving signal.

By introducing sequences of frame periods in which at least two frame periods of the sequence of frame periods have a different frame period duration and by selecting frame periods from a sequence of frame periods for providing, for example, pulses of the data-dependent signals to the pixels, the number of possible gray values has been increased, and the gray values can be generated more accurately. Compared to prior art embodiments offering a fixed frame period for making a number of combinations of frames by adding a frame or not during which the part of the driving signal is to be supplied, according to the invention one or more shorter frames and one or more longer frames can be combined arbitrarily. During the rest of the frames not chosen for driving a pixel, this pixel keeps its gray value due to the bi-stable character.

An embodiment of an electrophoretic display unit according to the invention is defined by claim 2. By delaying a start of a frame period, a frame period duration of a preceding frame period is adapted (extended with the delay time used for delaying the start of the frame period).

An embodiment of an electrophoretic display unit according to the invention is defined by claim 3. By supplying, for example, pulses of the data-dependent signals with a positive amplitude and with a negative amplitude, the net driving result is the difference between the pulses with the positive and negative amplitudes, to further increase the number of possible gray values.

An embodiment of an electrophoretic display unit according to the invention is defined by claim 4. By storing information about the frame periods to be selected for the driving signal, the one or more frame periods needed are automatically selected when selecting one of the driving signals to be supplied to a pixel.

An embodiment of an electrophoretic display unit according to the invention is defined by claim 5. Shaking pulses, for example, correspond with the pulses of the preset data signals discussed before. The driving pulses, for example, correspond with the pulses of the data-dependent signals discussed before. Reset pulses precede the driving pulses to further improve the optical response of the electrophoretic display unit, by defining a fixed starting point (fixed black or fixed white) for the driving pulses. Alternatively, reset pulses precede the driving pulses to further improve the optical response of the electrophoretic display unit, by defining a flexible starting point (black or white, to be selected in dependence on and closest to the gray value to be defined by the following driving pulses) for the driving pulses. The information is stored per combination of driving pulses, each combination corresponding to a possible gray value to be generated by the driving pulses.

An embodiment of an electrophoretic display unit according to the invention is defined by claim 6. In this embodiment the information is stored per combination of reset pulses, each combination corresponding to a possible gray value to be generated by the reset pulses.

The display device as claimed in claim 7 may be an electronic book, while the medium for storing information may be a memory stick, integrated circuit, a memory or other storage device for storing, for example, the content of a book to be displayed on the electrophoretic display unit.

Embodiments of a method according to the invention and of a processor program product according to the invention correspond with the embodiments of an electrophoretic display unit according to the invention.

The invention is based upon an insight, inter alia, that prior art with fixed frame periods results in a relatively inflexible driver, and is based upon a basic idea, inter alia, that selections of (combinations of) different frame periods with different frame period durations make the driver more flexible.

The invention solves the problem, inter alia, by providing an electrophoretic display unit with a relatively flexible driver, and is advantageous, inter alia, in that the number of possible gray values is increased and in that the gray values can be generated more accurately.

These and other aspects of the invention will be apparent from and elucidated with reference to the embodiments(s) described hereinafter.

In the drawings:

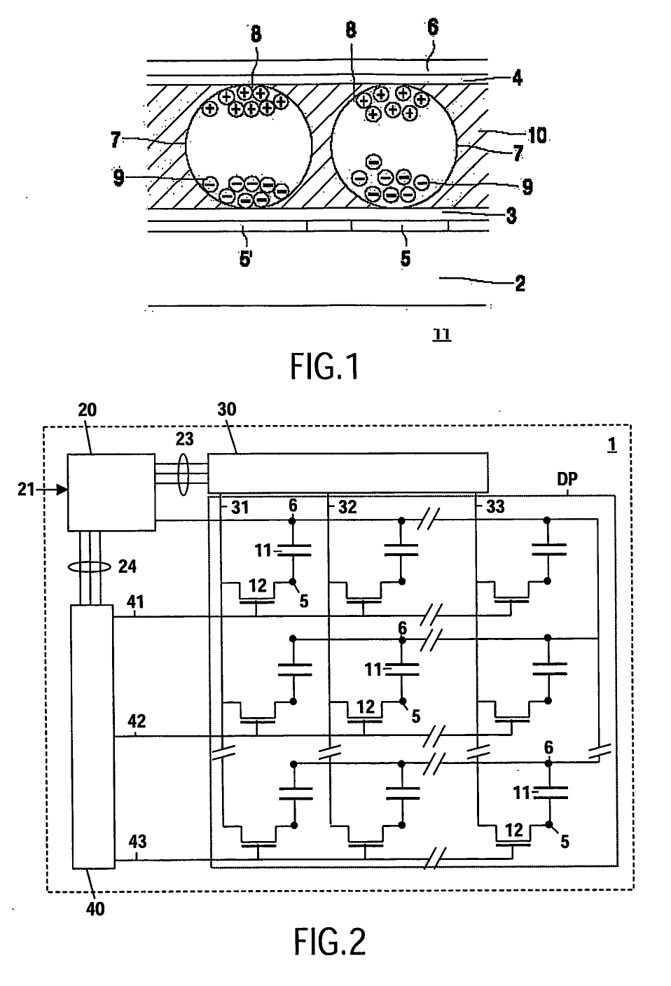

FIG. 1 shows (in cross-section) a pixel;

FIG. 2 shows diagrammatically an electrophoretic display unit;

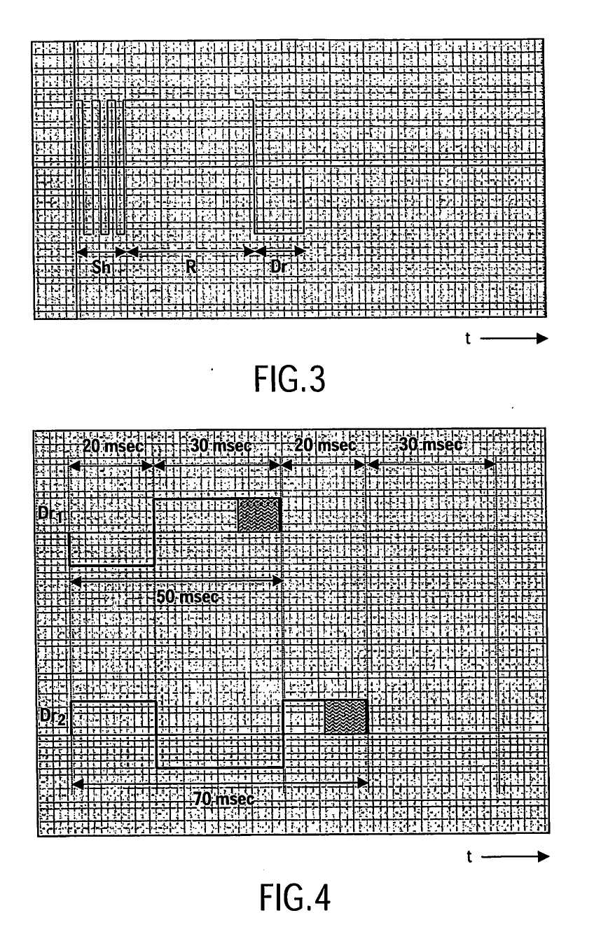

FIG. 3 shows a waveform for driving an electrophoretic display unit;

FIG. 4 shows two data-dependent signals according to the invention constructed via a sequence of frame periods according to the invention comprising different frame periods with different frame period durations; and

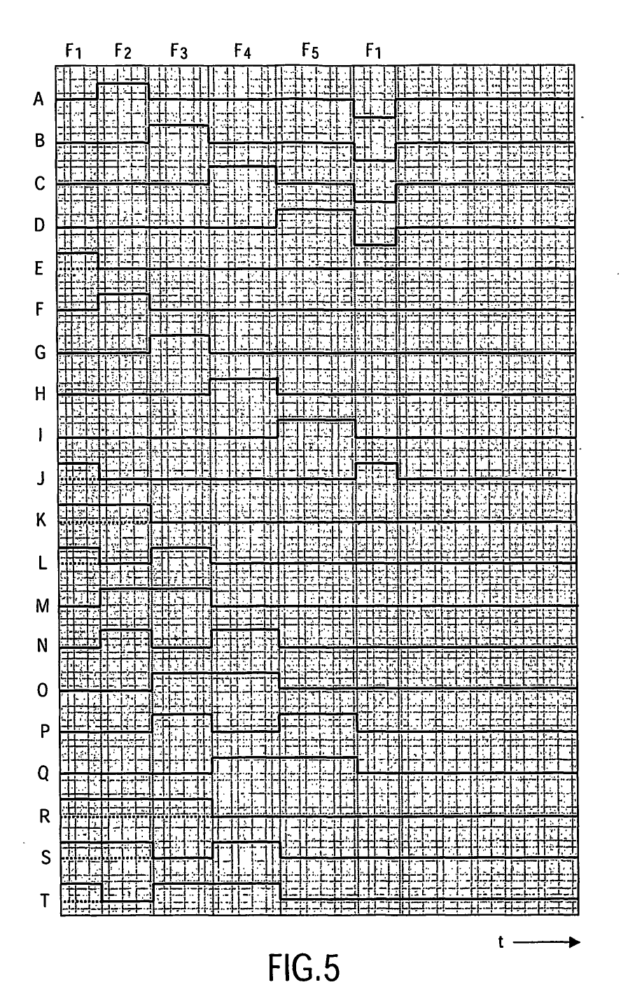

FIG. 5 shows twenty data-dependent signals according to the invention constructed via a sequence of frame periods according to the invention comprising different frame periods with different frame period durations.

The pixel 11 of the electrophoretic display unit shown in FIG. 1 (in cross-section) comprises a base substrate 2, an electrophoretic film (laminated on base substrate 2) with an electronic ink which is present between two transparent substrates 3,4 of, for example, polyethylene. One of the substrates 3 is provided with transparent pixel electrodes 5 and the other substrate 4 is provided with a transparent common electrode 6. The electronic ink comprises multiple microcapsules 7 of about 10 to 50 microns in diameter. Each microcapsule 7 comprises positively charged white particles 8 and negatively charged black particles 9 suspended in a fluid 10. When a positive field is applied to the pixel electrode 5, the white particles 8 move to the side of the microcapsule 7 directed to the common electrode 6, and the pixel becomes visible to a viewer. Simultaneously, the black particles 9 move to the opposite side of the microcapsule 7 where they are hidden from the viewer. By applying a negative field to the pixel electrode 5, the black particles 9 move to the side of the microcapsule 7 directed to the common electrode 6, and the pixel appears dark to a viewer (not shown). When the electric field is removed, the particles 8,9 remain in the acquired state and the display exhibits a bi-stable character and consumes substantially no power.

The electrophoretic display unit 1 shown in FIG. 2 comprises a display panel DP comprising a matrix of pixels 11 at the area of crossings of row or selection electrodes 41,42,43 and column or data electrodes 31,32,33. These pixels 11 are all coupled to a common electrode 6, and each pixel 11 is coupled to its own pixel electrode 5. The electrophoretic display unit 1 further comprises a row driver 40 coupled to the row electrodes 41,42,43 and a column driver 30 coupled to the column electrodes 31,32,33 and comprises an active switching element 12 for each pixel 11. The electrophoretic display unit 1 is driven by these active switching elements 12 (in this example (thin-film) transistors). The row driver 40 consecutively selects the row electrodes 41,42,43, while the column driver 30 provides data signals to the column electrode 31,32,33. Preferably, a controller 20 first processes incoming data arriving via input 21 and then generates the data signals. Mutual synchronization between the column driver 30 and the row driver 40 takes place via drive lines 23 and 24. Selection signals from the row driver 40 select the pixel electrodes 5 via the transistors 12 of which the drain electrodes are electrically coupled to the pixel electrodes 5 and of which the gate electrodes are electrically coupled to the row electrodes 41,42,43 and of which the source electrodes are electrically coupled to the column electrodes 31,32,33. A data signal present at the column electrode 31,32,33 is simultaneously transferred to the pixel electrodes 5 of the pixels 11 coupled to the drain electrode of the transistors 12. Instead of transistors, other switching elements can be used, such as diodes, MIMs, etc. The data signals and the selection signals together form (parts of) driving signals.

The controller 20, the row driver 40, and the column driver 30 together form the driving circuitry 20, 30, 40. This driving circuitry may be formed by one or more integrated circuits, which may be combined with other components in an electronic unit.

Incoming data, such as image information receivable via input 21 is processed by controller 20. Thereto, controller 20 detects an arrival of new image information about a new image and in response starts the processing of the image information received. This processing of image information may comprise the loading of the new image information, the comparing of previous images stored in a memory of controller 20 and the new image, the interaction with temperature sensors, the accessing of memories containing look-up tables of drive waveforms etc. Finally, controller 20 detects when this processing of the image information is ready.

Then, controller 20 generates the data signals to be supplied to column driver 30 via drive lines 23 and generates the selection signals to be supplied to row driver 40 via drive lines 24. These data signals comprise data-independent signals which are the same for all pixels 11 and data-dependent signals which may or may not vary per pixel 11. The data-independent signals comprise shaking pulses forming the preset pulses, with the data-dependent signals comprising one or more reset pulses and one or more driving pulses. These shaking pulses comprise pulses representing energy which is sufficient to release the electrophoretic particles 8,9 from a static state at one of the two electrodes 5,6, but which is too low to allow the particles 8,9 to reach the other one of the electrodes 5,6. Because of the reduced dependence on the history, the optical response to identical data will be substantially equal, regardless of the history of the pixels. So, the shaking pulses reduce the dependence of the optical response of the electrophoretic display unit on the history of the pixels. The reset pulse precedes the driving pulse to further improve the optical response, by defining a flexible starting point for the driving pulse. This starting point may be a black or white level, to be selected in dependence on and closest to the gray value defined by the following driving pulse. Alternatively, the reset pulse may form part of the data-independent signals and may precede the driving pulse to further improve the optical response of the electrophoretic display unit, by defining a fixed starting point for the driving pulse. This starting point may be a fixed black or fixed white level.

In FIG. 3, a waveform representing voltages across a pixel 11 as a function of time t is shown for driving an electrophoretic display unit 1. The waveform is generated using the data signals supplied via the column driver 30. The waveform comprises shaking pulses Sh, followed by a combination of reset pulses R and a combination of driving pulses Dr. For example, for an electrophoretic display unit with four gray levels, sixteen different waveforms are stored in a memory, like, for example, a look-up table memory etc. forming part of and/or coupled to controller 20. In response to data received via input 21, controller 20 selects a waveform for one or more pixels 11, and supplies the corresponding selection signals and data signals via the corresponding drivers 30,40 to the corresponding transistors 12 and the corresponding one or more pixels 11.

A frame period corresponds to a time-interval used for driving all pixels 11 in the electrophoretic display unit 1 once, by driving each row one after the other and by driving all columns once per row. For supplying data-independent signals to the pixels 11 during frames, column driver 30 is controlled in such a way by controller 20 that all pixels 11 in a row receive these data-independent signals simultaneously. This is done row by row, with controller 20 controlling row driver 40 in such a way that the rows are selected one after the other (all transistors 12 in the selected row are brought into a conducting state). For supplying data-dependent signals to the pixels 11 during frames, controller 20 controls row driver 40 in such a way that a first row is selected (all transistors 12 in this row are brought into a conducting state), after which column driver 30 is controlled in such a way by controller 20 that the pixels 11 in this row receive these data-dependent signals simultaneously via their transistors 12. Then a next row is selected by controller 20 etc.

The voltage levels of a pixel 11 shown in FIG. 3 require, per row, a row driving action for supplying the row driving signal (the selection signal) to the row for selecting (driving) this row, and a column driving action for supplying the data pulse to the pixel.

During a first set of frames, the shaking pulses Sh are supplied to the pixels 11, with each shaking pulse having a duration of one frame period. The first shaking pulse, for example, has a positive amplitude, the second one a negative amplitude, and the third one a positive amplitude etc. (alternating amplitudes), and therefore these shaking pulses do not change the gray value displayed by the pixel 11, as long as the frame period is relatively short.

During a second set of frames comprising one or more frame periods, the combination of reset pulses R is supplied, further to be discussed below. During a third set of frames comprising one or more frame periods, the combination of driving pulses Dr is supplied, with the combination of driving pulses Dr either having a duration of zero frame periods and in fact being a pulse having a zero amplitude or having a duration of one, two to, for example, fifteen frame periods. Thereby, a driving pulse Dr having a duration of zero frame periods, for example, corresponds with the pixel 11 displaying full black (in case the pixel 11 already displayed full black; in case of displaying a certain gray value, this gray value remains unchanged when being driven with a driving pulse having a duration of zero frame periods, or, formulated differently, when being driven with a pulse having a zero amplitude). The combination of driving pulses Dr having a duration of fifteen frame periods comprises fifteen subsequent pulses and, for example, corresponds with the pixel 11 displaying full white. The combination of driving pulses Dr having a duration of one to fourteen frame periods comprises one to fourteen subsequent pulses, which, for example, corresponds with the pixel 11 displaying one of a limited number of gray values between full black and full white.

The reset pulses R precede the driving pulses Dr to further improve the optical response of the electrophoretic display unit 1, by defining a fixed starting point (fixed black or fixed white) for the driving pulses Dr. Alternatively, reset pulses R precede the driving pulses Dr to further improve the optical response of the electrophoretic display unit, by defining a flexible starting point (black or white, to be selected in dependence on and closest to the gray value to be defined by the following driving pulses) for the driving pulses Dr.

As all frames have the same fixed duration, the driving of the prior art electrophoretic display unit 1 is highly inflexible. The number of gray values is limited, and cannot be increased, with the difference between two subsequent gray values being rather large.

FIG. 4 shows a first data-dependent signal Dr₁ and a second data-dependent signal Dr₂ as a function of time t according to the invention each comprising a first frame period of 20 msec. and a second frame period of 30 msec. The first data-dependent signal Dr₁ consists of a first section having a duration of 20 msec. and a negative amplitude and a second section having a duration of 30 msec. and a positive amplitude. The net effect of the first data-dependent signal Dr₁ is equivalent to a pulse having a duration of 10 msec. and a positive amplitude, as illustrated by the small pulse filled with waves. The second data-dependent signal Dr₂ comprises besides a positive section during the first frame and a negative section during the second frame a third frame period of 20 msec. with a positive amplitude. The net effect of the second data-dependent signal Dr₂ is equivalent to a pulse having a duration of 10 msec. and a positive amplitude, as illustrated by the small pulse filled with waves. So, the net effect of the data-dependent signal Dr₁ and Dr₂ is equivalent as each one of them has the same net duration and amplitude. However, data-dependent signal Dr₁ allows a lower number of switching actions and a higher driving speed. Furthermore, this example illustrates that net pulses of 10 msec. can be provided, although the smallest frame period applied is 20 msec.

These net pulses make a possible increase of the number of possible gray values as well as smaller steps of subsequent gray values possible. Desired gray values are generated by a combination of frames with a positive and/or a negative frame period. During frames which are not selected for driving a pixel, this pixel 11 keeps its gray value due to its bi-stable character.

A frame period may be extended by delaying a start of a subsequent frame period. Controller 20 comprises and/or is coupled to a memory (not shown) like, for example, a look-up table memory for storing a number of data-dependent signal Dr₁,Dr₂ each corresponding to a gray level to be generated. For each data-dependent signal comprising a combination of driving pulses, information is stored about which frame periods to select for providing the data-dependent signal to be supplied to a pixel 11. Of course, this information can also be stored per combination of reset pulses, to increase the number of possible gray values for the reset pulses.

FIG. 5 shows a sequence of frame periods according to the invention comprising five different frames F₁, F₂, F₃, F₄ and F₅ with different frame period durations of 20 msec., 24 msec., 28 msec., 32 msec., and 36 msec. respectively. Twenty different data-dependent signals A-T each comprising one or more sections are shown, constructed via selections of these different frames and having net durations of 4, 8, 12-80 msec. respectively.

Data-dependent signal A has a net duration of 4 msec. as the signal comprises a first part with a positive amplitude supplied during F₂ and a second part with a negative amplitude supplied during F₁. In a short notation, the net duration of A=F₂−F₁. The net durations of the data-dependent signals B-T are as follows. B=F₃−F₁. C=F₄−F₁. D=F₅−F₁. E=F₁. F=F₂. G=F₃. H=F₄. I=F₅. J=F₁+F₁. K=F₁+F₂. L=F₁+F₃. M=F₂+F₃. N=F₂+F₄. O=F₃+F₄. P=F₃+F₅. Q=F₄+F₅. R=F₁+F₂+F₃. S=F₁+F₂+F₄. T=F₁+F₃+F₄ etc. Of course, many alternatives are possible. As can be clearly derived from FIG. 5, by creating a sequence of frames periods, with different frame periods in the sequence having different frame period durations, the net data-dependent signals can be shorter than the shortest frame period duration F₁ of an electrophoretic display unit 1, allowing for smaller values than in prior art embodiments. This enables a more accurate reproduction of gray levels.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

The invention is based upon an insight, inter alia, that prior art with fixed frame periods results in a relatively inflexible driving, and is based upon a basic idea, inter alia, that selections of (combinations of) different frame periods with different frame period durations make the driving more flexible.

The invention solves the problem, inter alia, by providing an electrophoretic display unit with a relatively flexible driving, and is advantageous, inter alia, in that the number of possible gray values is increased and in that the gray values can be generated more accurately.

1. An electrophoretic display unit (1) comprising:
an electrophoretic display panel (DP) comprising a pixel (11);
a controller (20) for generating a driving signal in dependence of an input image by selecting frame periods from a sequence of frame periods for providing pulses to the pixel (11), at least two frame periods of the sequence of frame periods having a different frame period duration; and
drivers (30,40) for providing the pulses to the pixel (11) in response to the driving signal.

2. An electrophoretic display unit (1) as claimed in claim 1, wherein the controller (20) is arranged to delay a start of a frame period, thereby adapting a frame period duration of a preceding frame period.

3. An electrophoretic display unit (1) as claimed in claim 1, wherein the drivers (30,40) are arranged to supply pulses with a positive amplitude and with a negative amplitude.

4. An electrophoretic display unit (1) as claimed in claim 1, further comprising a memory coupled to the controller (20) for storing information about the frame periods to be selected for the driving signal.

5. An electrophoretic display unit (1) as claimed in claim 4, wherein the driving signal comprises a column driving signal and a row driving signal for providing
shaking pulses (Sh);
one or more reset pulses (R); and
one or more driving pulse (Dr),
with the information being stored per combination of driving pulses (Dr).

6. An electrophoretic display unit (1) as claimed in claim 4, wherein the driving signal comprises a column driving signal and a row driving signal for providing:
shaking pulses (Sh);
one or more reset pulses (R); and
one or more driving pulses (Dr),
with the information being stored per combination of reset pulses (R).

7. A display device comprising an electrophoretic display unit (1) as claimed in claim 1; and a medium for storing information to be displayed on the display unit (1).

8. A method of driving an electrophoretic display unit (1) which comprises an electrophoretic display panel comprising a pixel (11), the method comprising the steps of:
generating a driving signal in dependence on an input image by selecting frame periods from a sequence of frame periods for providing pulses to the pixel (11), at least two frame periods of the sequence of frame periods having a different frame period duration; and
in response to the driving signal providing the pulses to the pixel (11).

9. A computer program product for driving an electrophoretic display unit (1) which comprises an electrophoretic display panel comprising a pixel (11), the computer program product comprising the functions of:
generating a driving signal in dependence on an input image by selecting frame periods from a sequence of frame periods for providing pulses to the pixel (11), at least two frame periods of the sequence of frame periods having a different frame period duration; and
providing the pulses to the pixel (11) in response to the driving signal.

10. Driving circuitry (20, 30, 40) for an electrophoretic display unit (1) comprising an electrophoretic display panel (DP) comprising a pixel (11), the driving circuitry (20, 30, 40) comprising:
a controller (20) for generating a driving signal in dependence on an input image by selecting frame periods from a sequence of frame periods providing pulses to the pixel (11), at least two frames periods of the sequence of frame periods having a different frame period duration; and
drivers (30, 40) for providing the pulses to the pixel (11) in response to the driving signal.
